(19) United States
(12) Patent Application Publication
(10) Pub. No.: US 2009/0260236 A1
(43) Pub. Date: Oct. 22, 2009

(54) KNIFE OF A BLENDER

(76) Inventor: Kuan-Chih LIN, Jen Der Hsiang (TW)

Correspondence Address: Kuan-Chih LIN, P.O. BOX 8-71, Tainan, 71052, TW

(21) Appl. No.: 12/103,715

(22) Filed: Apr. 16, 2008

(51) Int. Cl. B26D 1/25; A47J 43/00; B26D 7/00

(52) U.S. Cl. 30/265; 99/537; 83/167

(57) ABSTRACT

This invention relates to a knife of a blender that includes a container, the knife fixed on a bottom of the container, and a base located under the container. The knife is provided with an upper blade having its ends inclined upward, a lower blade having its two ends inclined downward, and a shearing blade installed between the upper blade and the lower blade. Each of the upper blade and the lower blade has a shear edge used as a cutting means. The shearing blade is shaped similar to “S”, provided with two shearing edges symmetrically formed on two end portions, and a plurality of teeth formed along each of the shearing edges with diverse depth. By means of the knife, frozen or semi-frozen fruits can be finely crushed quickly, and fruits and vegetables can be completely blended into juice.

### BACKGROUND OF THE INVENTION

1. Field of the Invention

This invention relates to a knife of a blender, particularly to one able to finely crush frozen and semi-frozen fruits quickly, and blend fruits and vegetables into juice.

2. Description of the Prior Art

Commonly, as shown in FIG. 1, a conventional blender 1 is composed of a container 10, a knife 11 fixed on a bottom of the container 10, and a base 12 located under the container 10 for accommodating a motor and its relevant cords and accessories to drive the knife 11 to spin. The knife 11 is usually provided with two pairs of blades, with one symmetrically inclined upward and the other symmetrically inclined downward, always unable to blend well or needing a longer time for blending, apt to greatly lose vitamins in vegetables and fruits. Moreover, provided frozen or semi-frozen fruits are to be blended, it is more difficult to effectively blend them by the knife 11 of the blender 1. So, the invention has been devised to overcome the defects mentioned above.

### SUMMARY OF THE INVENTION

The object of this invention is to offer a knife of a blender for quickly crushing ice blocks or completely blending fruits and vegetables into juice.

The main characteristics of the invention are an upper blade, a lower blade and a shearing blade installed between the upper blade and the lower blade, with the shearing blade provided with two shearing edges symmetrically formed on two end portions and a plurality of teeth formed along each of the shearing edges with diverse depth.

### BRIEF DESCRIPTION OF DRAWINGS

This invention is better understood by referring to the accompanying drawings, wherein:

FIG. 1 is a perspective view of a conventional blender;

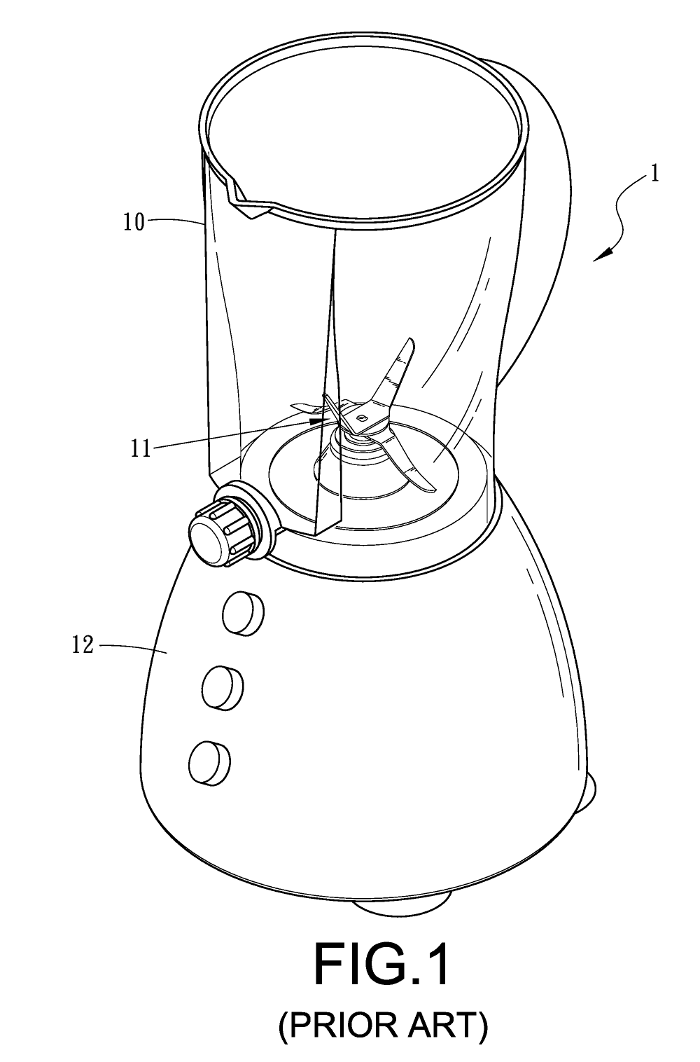

FIG. 2 is a perspective view of a preferred embodiment of a knife of a blender in the present invention, showing it being installed in the blender;

FIG. 3 is a perspective view of a shearing blade of the preferred embodiment of a knife of a blender in the present invention; and

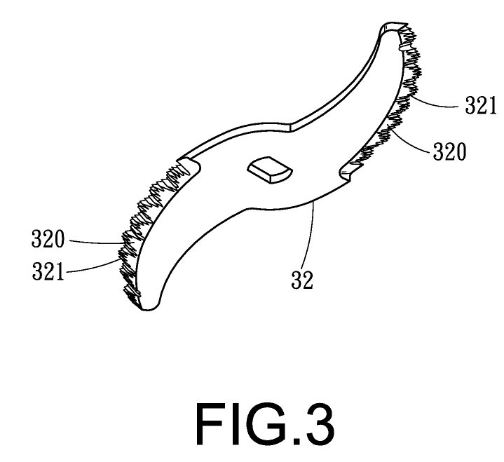

FIG. 4 is a perspective view of the preferred embodiment of a knife of a blender in the present invention.

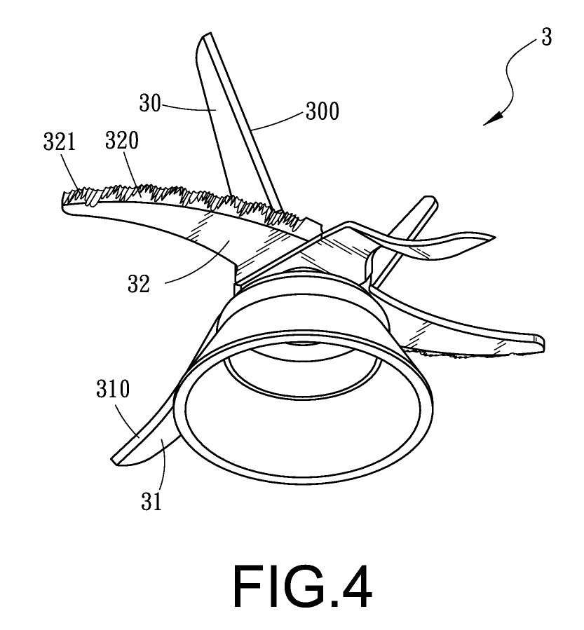

### DETAILED DESCRIPTION OF THE PREFERRED EMBODIMENT

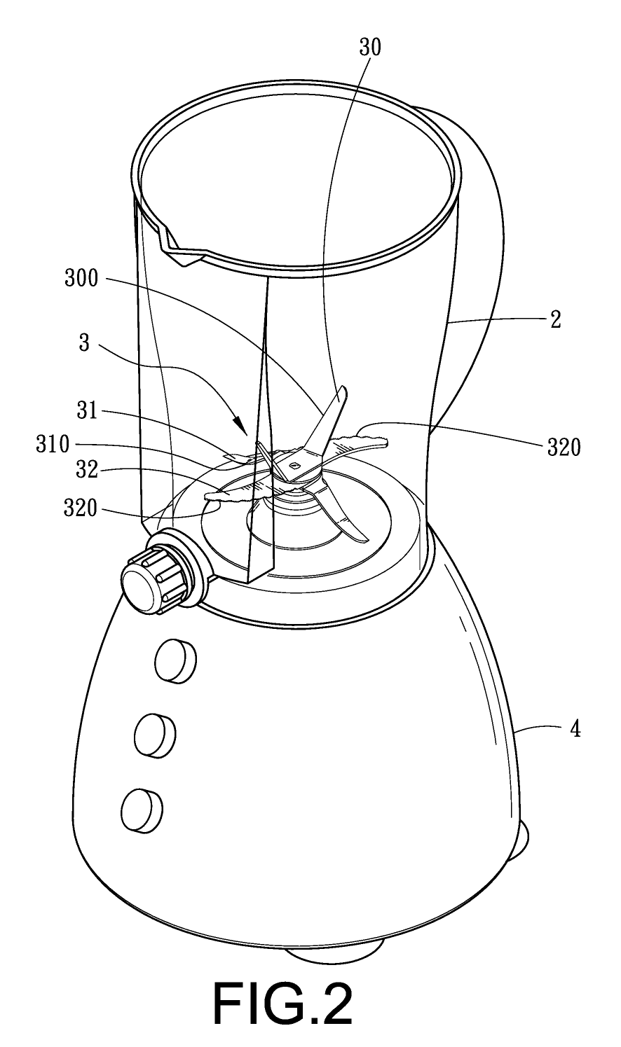

FIGS. 2˜4 show a preferred embodiment of a knife 3 of a blender in the present invention. The blender includes a container 2, the knife 3 fixed on a bottom of the container 2, and a base 4 located under the container 2. The knife 3 is provided with an upper blade 30, a lower blade 31 and a shearing blade 32 installed between the upper blade 30 and the lower blade 31. The upper blade 30 is provided with a shearing edge 300 formed as its cutting side, having its two end portions inclined upward. The lower blade 31 is also provided with a shearing edge 310 formed as its cutting side, having its two end portions inclined downward. The shearing blade 32 is shaped similar to “S”, provided with two shearing edges 320 symmetrically formed on two end portions, and a plurality of teeth 321 formed along each of the shearing edges 320 with diverse depth.

In using, referring to FIGS. 2˜4 again, foods to be blended are first put in the container 2 and then, turn on the electric devices in the base 4 to drive the knife 3 to counterclockwise whirl. By means of the upper blade 30, the foods can be firstly cracked into smaller pieces. Next, with the irregular teeth 321 of the shearing blade 32, the foods, especially frozen or semi-frozen fruits, can be horizontally chopped up, sawed, chipped and cut quickly. Then, with the lower blade 31, the foods can be turbulently blended to be further juiced or the ice blocks can be finely homogeneously cracked.

The invention has the following advantages as can be seen from the foresaid description.

1. With the upper blade 30, the lower blade 31 and the shearing blade 32 located at different levels, fruits or vegetables can be quickly cut and blended into juice, with few dregs left.

2. Quickly chopped up, sawed, chipped and cut by the shearing blade 320 and the irregular teeth 321 of the shearing blade 32 and turbulently blended by the upper blade 30 and the lower blade 31, the foods, especially frozen or semi-frozen fruits, can be finely and homogeneously blended.

While the preferred embodiment of the invention has been described above, it will be recognized and understood that various modifications may be made therein and the appended claims are intended to cover all such modifications that may fall within the spirit and scope of the invention.

What is claimed is:

1. A knife of a blender that includes a container, said knife fixed on a bottom of said container, a base located under said container, said knife provided with an upper blade and a lower blade and a shearing blade, each of said upper blade and said lower blade and said shearing blade provided with a shearing edge used as a cutting means, said upper blade having its two end portions inclined upward, said lower blade having its two end portions inclined downward; and
said knife characterized by that said shearing blade is installed between said upper blade and said lower blade, said shearing blade provided with two shearing edges symmetrically formed on two end portions, a plurality of teeth formed along each of said shearing edges with diverse depth.

2. The knife of a blender as claimed in claim 1, wherein said shearing blade has said teeth and said shearing edges formed under its edge.

3. The knife of a blender as claimed in claim 1, wherein said shearing blade is shaped similar to “S”.
